(19) United States
(12) Patent Application Publication
(10) Pub. No.: US 2022/0282711 A1
(43) Pub. Date: Sep. 8, 2022

(54) SUPPORT SYSTEM FOR MAIN SHAFT OF WIND TURBINE

(71) Applicant: LiftWerx Holdings Inc., Cambridge (CA)

(72) Inventors: Glen D. AITKEN, Fergus (CA); Eelko MAIJ, Wateringen (NL)

(21) Appl. No.: 17/635,722

(22) PCT Filed: Aug. 19, 2020
(86) PCT No.: PCT/CA2020/051130

§ 371 Date: Feb. 16, 2022

Related U.S. Application Data
(60) Provisional application No. 62/899,315, filed on Sep. 12, 2019.

(51) Int. Cl. F03D 80/50; F03D 15/00

(52) U.S. Cl. CPC F03D 80/50; F03D 15/00; F05B 2260/4031; F05B 2240/60

(57) ABSTRACT

A support system supports and immobilizes a main shaft in a nacelle of a wind turbine when a gearbox has been dismounted from the main shaft. The support system has a main shaft fixture situatable above the main shaft for engagement with an upper surface of the main shaft. The main shaft fixture has an arcuate recess to engage with the main shaft from above, but has no structure to support the main shaft from below. The main shaft fixture is adapted to be supported on and secured to longitudinal rails of the nacelle. A jack separate from the main shaft fixture is supportable on a floor of the nacelle beneath the main shaft, and is extendible to engage a bottom surface of the main shaft to support the main shaft from below and to raise the main shaft up and into the arcuate recess of the main shaft fixture.

### CROSS-REFERENCE TO RELATED APPLICATIONS

This application claims the benefit of U.S. Provisional Patent Application Ser. No. 62/899,315 filed Sep. 12, 2019, the entire contents of which is herein incorporated by reference.

### FIELD

This application relates to wind turbines, in particular to accessories for use in supporting a main shaft of a wind turbine during replacement or maintenance of a gearbox.

### BACKGROUND

Wind turbines comprise a tall tower at the top of which is mounted a rotor having rotor blades and a hub to which the rotor blades are mounted. The hub is mounted at one end of a main shaft, which extends generally horizontally from the hub into a nacelle of the wind turbine. The other end of the main shaft is mounted in a gearbox in the nacelle, with the gearbox connected to a generator. Wind is caught by the rotor blades to turn the hub, which in turn rotates the main shaft, which drives the gears to drive the generator to generate electricity. The main shaft, gearbox and generator are located in the nacelle atop the tower, the nacelle essentially being a compartment in which to house turbine components.

To efficiently repair or replace a gearbox, it is necessary to dismount the gearbox from the end of the main shaft and lower the gearbox to the ground. After repair, or if replacement is desired, a gearbox is raised back up to the nacelle and remounted on the end of the main shaft.

However, the gearbox also anchors the end of the main shaft, so when the gearbox is initially dismounted, the weight of the rotor at the other end of the main shaft would cause the main shaft to tilt, which can cause the entire rotor to fall to the ground, or at least cause damage to the main shaft, nacelle and/or the rotor.

To prevent tilting of the main shaft, one of two strategies is employed. In a first and more elaborate strategy, the rotor is removed from the main shaft before the gearbox is dismounted from the main shaft, and the rotor is lowered to the ground. This requires a large crane and considerable time. In a second strategy, to avoid having to remove the rotor, a ‘main shaft fixture’ is raised up to the nacelle and used to hold the main shaft down prior to dismounting the gearbox. Various main shaft fixtures are known in the art, but generally suffer from one or more problems including being complex to install, being difficult to use, being useable on only one type of wind turbine and/or only being able to support the main shaft without immobilizing rotation of the main shaft, among others.

There remains a need in the art for a main shaft fixture that solves one or more of the problems with existing main shaft fixtures.

### SUMMARY

In one aspect, there is provided a support system for supporting and immobilizing a main shaft in a nacelle of a wind turbine when a gearbox has been dismounted from the main shaft, the support system comprising: a main shaft fixture situatable above the main shaft for engagement with an upper surface of the main shaft, the main shaft fixture comprising an arcuate recess to engage with the main shaft from above the main shaft but comprising no structure to support the main shaft from below the main shaft, the main shaft fixture adapted to be supported on longitudinal rails of the nacelle and secured to the longitudinal rails from above the longitudinal rails; and, a jack separate from the main shaft fixture and not a part of the main shaft fixture, the jack supportable on a floor of the nacelle beneath the main shaft, the jack extendible to engage a bottom surface of the main shaft to support the main shaft from below the main shaft and to raise the main shaft up and into the arcuate recess of the main shaft fixture.

The system is useful for supporting and immobilizing the main shaft of a wind turbine during maintenance or replacement of the gearbox of the wind turbine. The main shaft is both supported to prevent tilting and immobilized to prevent rotation of the main shaft.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a top rear perspective view of components of a wind turbine in a nacelle of the wind turbine, in which a support system of the present invention supports a main shaft when a gearbox has been dismounted for replacement or repair;

FIG. 2A depicts a rear view of FIG. 1;

FIG. 2B depicts a rear view of FIG. 1 normal to a rear of a main shaft fixture of the support system;

FIG. 3A depicts a top view of FIG. 1;

FIG. 3B depicts a top view of FIG. 1 normal to a top of a main shaft fixture of the support system;

FIG. 4A depicts a perspective view of the main shaft fixture of the support system;

FIG. 4B depicts FIG. 4A without bolts in bolt holes and with hidden structure shown in dashed lines;

FIG. 5 depicts a top view of the main shaft fixture of the support system with hidden structure shown in dashed lines;

FIG. 6 depicts a rear view of the main shaft fixture of the support system with hidden structure shown in dashed lines;

FIG. 7 depicts an end view of the main shaft fixture of the support system without bolts through bolt holes and with hidden structure shown in dashed lines;

FIG. 8 depicts a top view of a top plate of the main shaft fixture of FIG. 4A;

FIG. 9 depicts a side view of a support plate of the main shaft fixture of FIG. 4A;

FIG. 10 depicts an end view of a half-pipe plate of the main shaft fixture of FIG. 4A; and,

FIG. 11 depicts an end view of an inner plate assembly of the main shaft fixture of FIG. 4A.

### DETAILED DESCRIPTION

In some embodiments, the main shaft fixture may comprise support wings extending laterally toward distal ends of the support wings with respect to a longitudinal axis of the main shaft when the main shaft fixture is engaged with the main shaft. The support wings have proximal ends at or proximate the longitudinal axis of the main shaft, and distal ends more distant from the longitudinal axis of the main shaft. In some embodiments, the support wings may be contoured and shaped to adapt the main shaft fixture to being supported on the longitudinal rails. For example, to adapt the main shaft fixture to being supported on the longitudinal rails, the support wings may comprise at least partially sinusoidal bottom edges extending between the arcuate recess and the distal ends of the support wings. The support wings may further comprise vertically-oriented bolt holes proximate the distal ends of the support wings through which bolts are insertable to secure the main shaft fixture to the longitudinal rails from above the longitudinal rails.

In a particularly preferred embodiment, the main shaft fixture may comprise a horizontally-oriented top plate, at least two vertically-oriented parallel spaced-apart support plates attached to and extending downwardly from a bottom surface of the top plate and a half-pipe plate having a convex upper surface attached to the bottom edges of the support plates. The top plate may have a flat top surface. The top plate may be securable to and extending laterally between the longitudinal rails with respect to the longitudinal axis of the main shaft when the main shaft fixture is engaged with the main shaft. The top plate may have vertically-oriented bolt holes proximate ends of the top plate through which bolts are insertable to secure the top plate to the longitudinal rails from above the longitudinal rails. The support plates may be attached to and extending downwardly from a bottom surface of the top plate, The support plates may have bottom edges comprising arcuate notches that divide each of the support plates into two sections extending laterally toward distal ends of the sections with respect to the longitudinal axis of the main shaft when the main shaft fixture is engaged with the main shaft. The sections of the support plates may comprise at least partially sinusoidal bottom edges extending between the arcuate notches and the distal ends of the sections. The half-pipe plate may have a convex upper surface attached to the bottom edges of the support plates within the arcuate notches of the support plates. The half-pipe plate may have a concave inner surface defining the arcuate recess of the main shaft fixture. The main shaft fixture may further comprise inner-plate assemblies extending between and attached to inner surfaces of the parallel spaced-apart support plates. The inner-plate assemblies may be further attached to the bottom surface of the top plate and the convex upper surface of the half-pipe plate.

In some embodiments, the arcuate recess may be an inverted U-shaped recess. The arcuate recess may be lined with a flexible buffer. The flexible buffer may comprise an elastomeric material, for example natural rubber or a synthetic polymer. The flexible buffer may conform to the shape of the arcuate recess. The flexible buffer may have a high coefficient of friction to assist with immobilizing the main shaft against rotation. The flexible buffer helps prevent damage to the main shaft when the main shaft is engaged with the arcuate recess.

The jack is separate from the main shaft fixture and is supportable on a bed plate on a floor of the nacelle beneath the main shaft. In some embodiments, the jack is a pedestal jack. In some embodiments, the jack is a hydraulic jack. The jack may be a hydraulic pedestal jack. The jack is not part of the main shaft fixture, although the jack works in tandem with the main shaft fixture to support and immobilize the main shaft. The jack is extendible to engage a bottom surface of the main shaft to support the main shaft from below and to raise the main shaft up and into the arcuate recess of the main shaft fixture to clamp the main shaft between the jack and the bottom surface of the arcuate recess. The main shaft is thereby both supported and immobilized by the support system. A separate rotor lock may also be used to immobilize rotation of the rotor, and therefore help immobilize rotation of the main shaft.

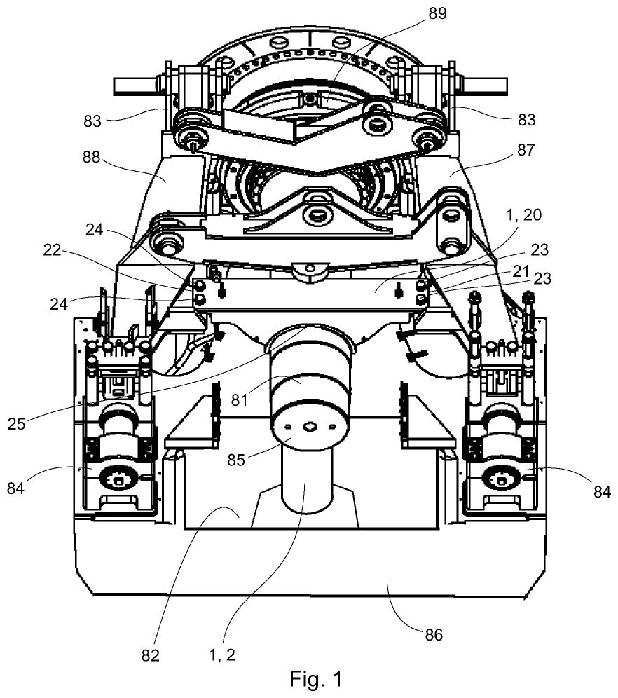

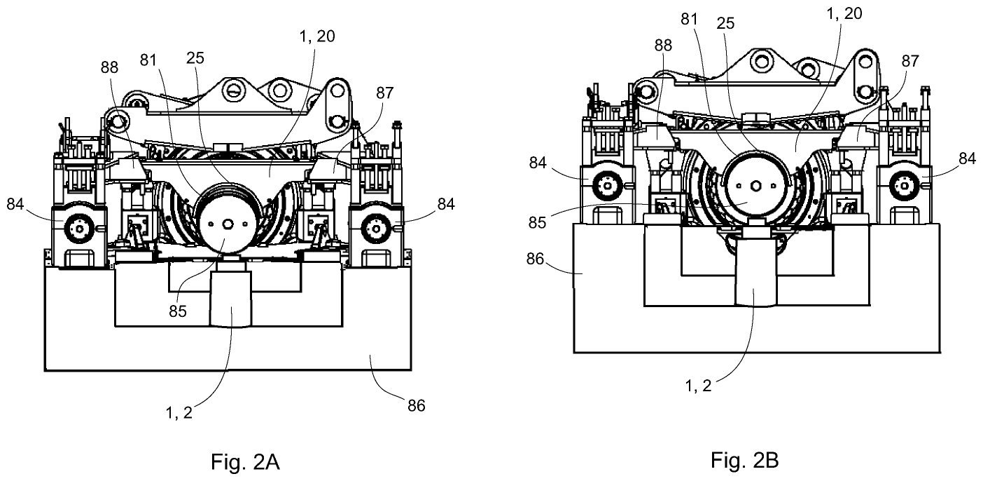

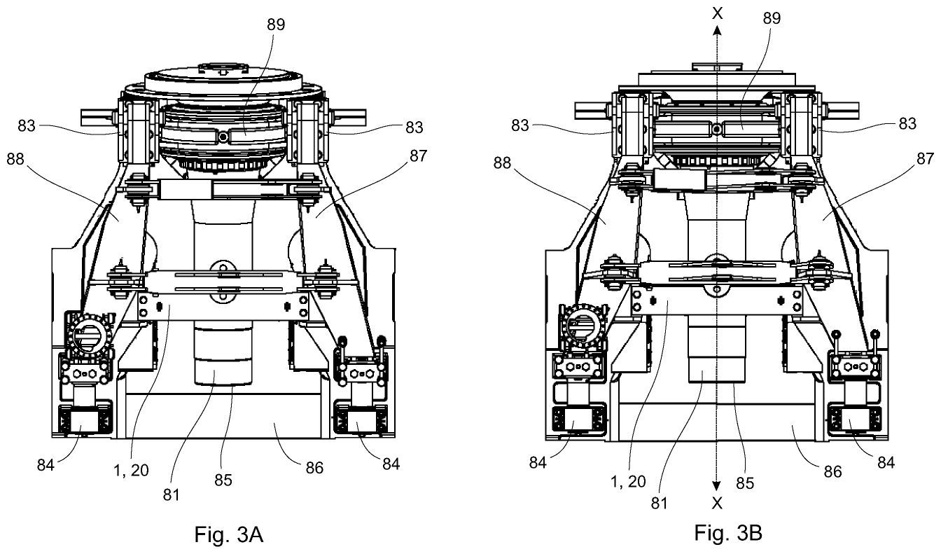

With reference to FIG. 1 to FIG. 3B, one embodiment of a support system 1 of the present invention is depicted while being used to support and immobilize a main shaft 81 of a wind turbine in a nacelle of the wind turbine when a gearbox has been dismounted from the main shaft 81 for replacement or repair. The support system 1 comprises a hydraulic pedestal jack 2 and a main shaft fixture 20. The jack 2 is positioned and supported on a bed plate 86 on a floor 82 of the nacelle underneath the main shaft 81 at a longitudinal position between main bearing supports 83 and pillow blocks 84 in the nacelle, the main bearing supports 83 and the pillow blocks 84 supported on the bed plate 86. The main bearing supports 83 support a main bearing 89 at a front of the nacelle. The jack 2 is laterally positioned in the nacelle directly under a longitudinal axis X-X of the main shaft 81. The main shaft fixture 20 is positioned above the main shaft 81 at the same longitudinal position as the jack 2, although the main shaft fixture 20 and the jack 2 may be longitudinally offset from each other to some extent provided the main shaft fixture 20 and the jack 2 can both function in the desired manner to support and immobilize the main shaft 81. The positions of the jack 2 and the main shaft fixture 20 are positions where the main shaft 81 is accessible when the gearbox is still mounted on a rear end 85 of the main shaft 81. The main shaft fixture 20 straddles the main shaft 81, and ends 21, 22 of the main shaft fixture 20 are secured to longitudinal rails 87, 88 of the nacelle from above longitudinal rails 87, 88 by a plurality of bolts 23, 24, respectively. An arcuate recess 25 in an underside of the main shaft fixture 20 has a complementary curvature to a curvature of the main shaft 81 so that the main shaft fixture 20 can be seated snugly on an upper surface of the main shaft 81.

When installing the system 1, the main shaft fixture 20 is first installed over top of the main shaft 81, followed by installing the jack 2 below the main shaft 81. With the main shaft fixture 20 bolted to longitudinal rails 87, 88, the gearbox is removed and the main shaft 81 is prevented from tilting upward at the rear end 85 because the main shaft fixture 20 holds down the main shaft 81. The jack 2 is operated to engage a lower surface of the main shaft 81 to lift the main shaft 81 fully into the arcuate recess 25 thereby clamping the main shaft 81 to the main shaft fixture 20. In clamping the main shaft 81 to the main shaft fixture 20, the jack 2 prevents the main shaft 81 from rotating with the gearbox dismounted.

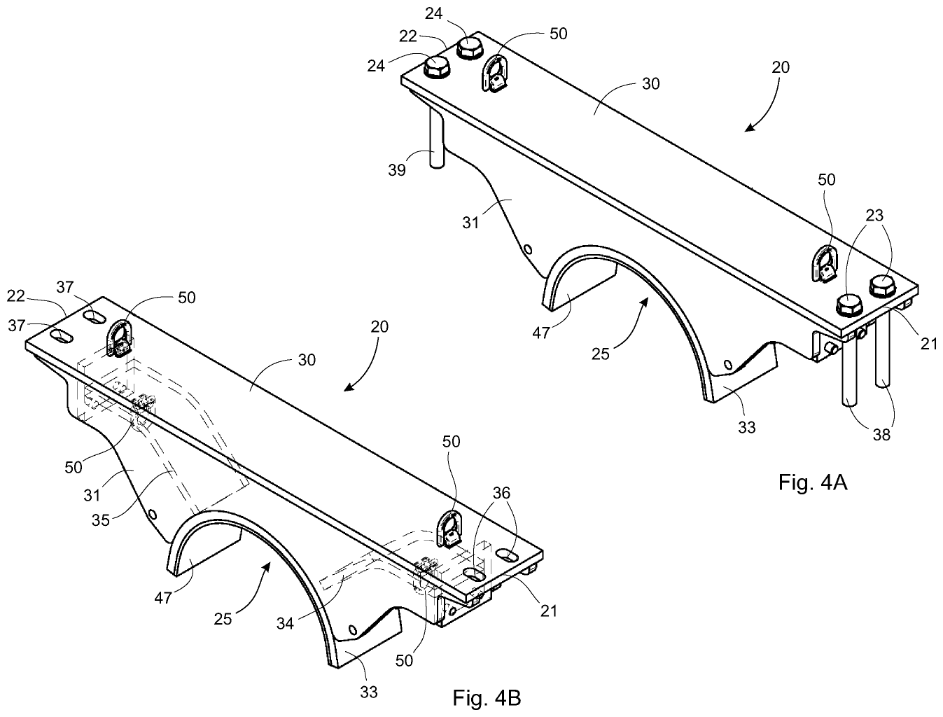

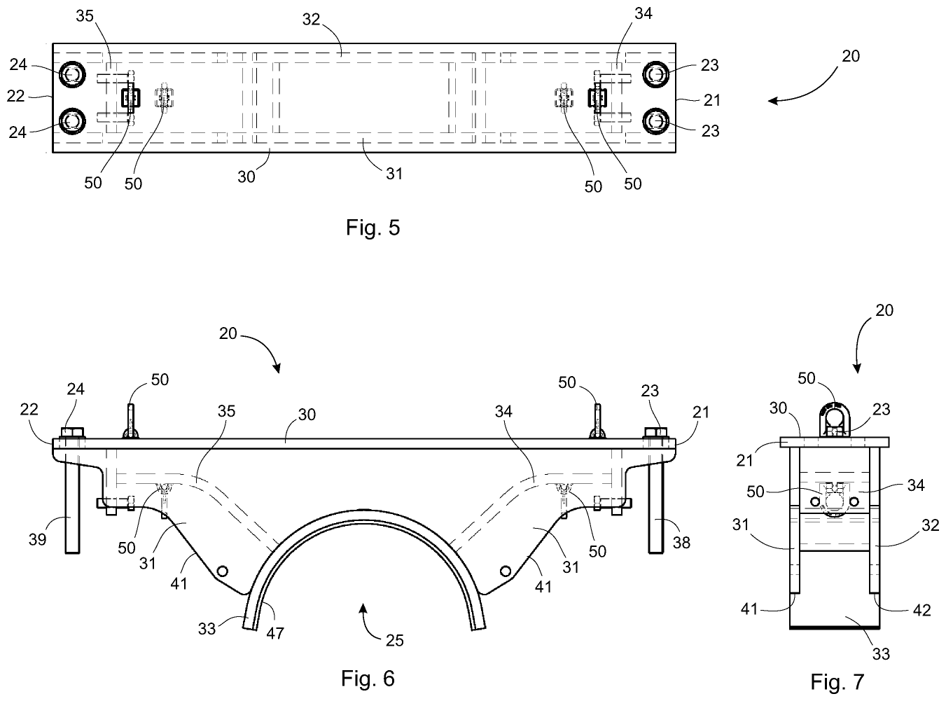

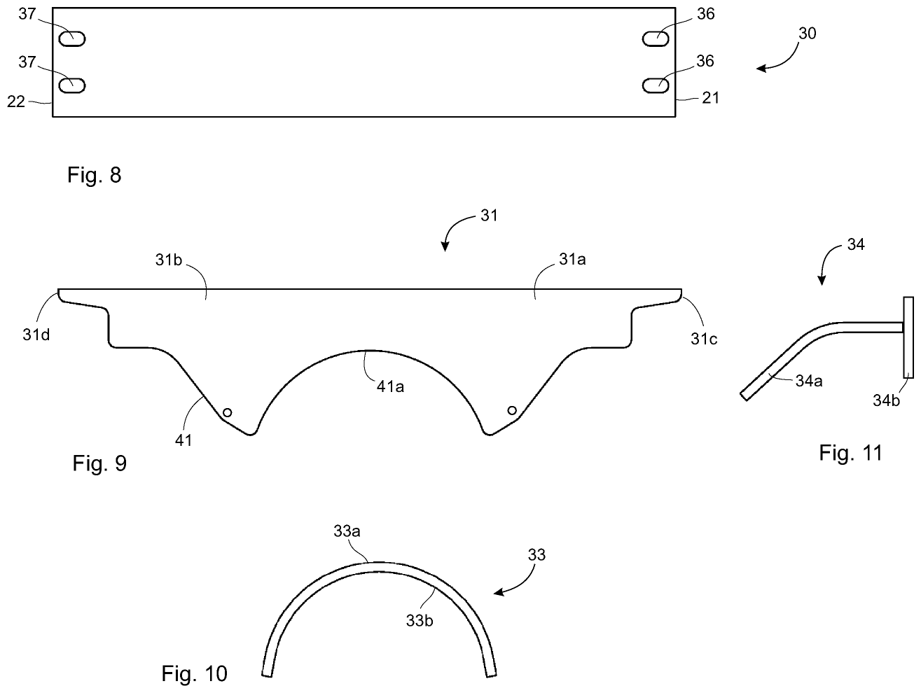

Referring to FIG. 4A to FIG. 11, the main shaft fixture 20 comprises a top plate 30, a first support plate 31, a second support plate 32, a half-pipe plate 33, a first inner-plate assembly 34 and a second inner-plate assembly 35.

The top plate 30 has a bottom surface and a flat top surface, the top plate 30 being horizontally and transversely oriented with respect to the longitudinal axis X-X of the main shaft 81 when the main shaft fixture 20 is mounted on the longitudinal rails 87, 88. Thus ends of the top plate 30 are the ends 21, 22 of the main shaft fixture 20. The top plate 30 further comprises vertically-oriented bolt holes 36, 37 proximate the ends 21, 22 of the top plate 30 through which bolts 23, 24, respectively, are insertable to secure the top plate 30 to the longitudinal rails 87, 88 from above the longitudinal rails 87, 88. The bolt holes 36, 37 may be provided with bolt sleeves 38, 39, respectively, which are attached to the bottom surface of the top plate 30 around the bolt holes 36, 37 and which extend vertically downward from the bottom surface of the top plate 30. The bolt sleeves 38, 39 act as spacers between the top plate 30 and the longitudinal rails 87, 88.

The first support plate 31 and the second support plate 32 are attached to the bottom surface of the top plate 30, preferably by welding although the support plates could each be integrally formed as one piece with the top plate or attached to the top plate by fasteners (e.g. bolts, rivets or the like). The first support plate 31 and the second support plate 32 are vertically oriented and extend downwardly from the bottom surface of the top plate 30. The first support plate 31 and the second support plate 32 are parallel to each other and longitudinally spaced-apart with respect to the longitudinal axis X-X of the main shaft 81 when the main shaft fixture 20 is mounted on the longitudinal rails 87, 88. The support plates 31, 32 each have bottom edges 41, 42, respectively, comprising arcuate notches that divide each of the support plates 31, 32 into two sections extending laterally toward distal ends of the sections. When the support plates 31, 32 are attached to the top plate 30, the distal ends of the sections are proximate the ends 21, 22 of the main shaft fixture 20. The bottom edges 41, 42 of the support plates 31, 32, respectively, are at least partially sinusoidal in the sections between the arcuate notches and the distal ends of the sections. With specific reference to FIG. 9, the first support plate 31 is depicted where the bottom edge 41 comprises the arcuate notch 41a dividing the support plate 31 into a first section 31a and a second section 31b on either side of the arcuate notch 41a. The bottom edge 41 is partially sinusoidal in each of the two sections 31a, 31b between the arcuate notch 41a and the distal ends 31c, 31d of the sections 31a, 31b, respectively. The second support plate 32 is similarly designed.

The half-pipe plate 33 has a convex upper surface 33a (see FIG. 10) attached to the bottom edges 41, 42 of the support plates 31, 32 within the arcuate notches of the support plates 31, 32. Only the arcuate notch 41a in the bottom edge 41 of the first support plate 31 is labeled as shown in FIG. 9, however the second support plate 32 is the same. The half-pipe plate 33 has a concave inner surface 33b defining the arcuate recess 25 of the main shaft fixture 20. The half-pipe plate 33 attached to the bottom edges 41, 42 of the support plates 31, 32 preferably by welding, although the half-pipe plate 33 could each be integrally formed as one piece with one or both of the support plates 31, 32 or attached to the support plates 31, 32 by fasteners (e.g. bolts, rivets or the like). The half-pipe plate 33 may be provided with a flexible buffer 47, which lines the concave inner surface 33b of the half-pipe plate 33. The flexible buffer 47 may comprise any suitable flexible material, for example natural rubber or synthetic elastomers, to provide a cushion between the half-pipe plate 33 and the main shaft 81 when the main shaft 81 is clamped in the main shaft fixture 20, thereby preventing damage to the main shaft 81 and/or the main shaft fixture 20.

The first inner-plate assembly 34 and the second inner-plate assembly 35 are the same, each extending between and attached to inner surfaces of the parallel spaced-apart support plates 31, 32. The inner-plate assemblies 34, 35 are further attached to the bottom surface of the top plate 30 and the convex upper surface 33a of the half-pipe plate 33. The first and second inner-plate assemblies 34, 35, respectively, are situated at the ends 21, 22, respectively, of the main shaft fixture 20 underneath the top plate 30 and between the support plates 31, 32. With reference to the first inner-plate assembly 34 depicted in FIG. 11, the inner-plate assembly comprises a vertically oriented connector plate 34a and a horizontally oriented connector plate 34b attached, preferably by welding, along a distal end edge of the horizontally oriented connector plate 34b to a face of the vertically oriented connector plate 34a. The vertically oriented connector plate 34a is attached to the bottom surface of the top plate 30, preferably by welding, and to inner faces of the support plates 31, 32, preferably by welding. The horizontally oriented connector plate 34b comprises a downward bend and is attached, preferably by welding, along side edges to the inner faces of the support plates 31, 32, and on a proximal end edge to the convex upper surface 33a of the half-pipe plate 33. The inner-plate assemblies 34, 35 provide further rigidity and structural integrity to the main shaft fixture 20.

The main shaft fixture 20 further comprises various rigging shackles 50, to which rigging lines may be attached to assist with installing and uninstalling the main shaft fixture 20 on the longitudinal rails 87, 88.

The support system of the present invention advantageously permits securing the main shaft fixture in the nacelle of the wind turbine from the top of the main shaft fixture. Using the longitudinal rails as securement structures permits securing the main shaft fixture with simple bolts from above, which is a much simpler, accessible and more efficient way of installing a main shaft fixture. Having a separate jack situatable under the main shaft to immobilize the main shaft in the main shaft fixture also provides greater flexibility in the installation procedure while providing an immobilization function. The system requires much less effort to install and has fewer components than prior art main shaft fixtures, and installation of the present system is not impeded as much by nacelle components.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A support system for supporting and immobilizing a main shaft in a nacelle of a wind turbine when a gearbox has been dismounted from the main shaft, the support system comprising:
a main shaft fixture situatable above the main shaft for engagement with an upper surface of the main shaft, the main shaft fixture comprising an arcuate recess to engage with the main shaft from above the main shaft but comprising no structure to support the main shaft from below the main shaft, the main shaft fixture adapted to be supported on longitudinal rails of the nacelle and secured to the longitudinal rails from above the longitudinal rails; and,
a jack separate from the main shaft fixture and not a part of the main shaft fixture, the jack supportable on a floor of the nacelle beneath the main shaft, the jack extendible to engage a bottom surface of the main shaft to support the main shaft from below the main shaft and to raise the main shaft up and into the arcuate recess of the main shaft fixture.

2. The system of claim 1, wherein the arcuate recess is an inverted U-shaped recess.

3. The system of claim 1, wherein the main shaft fixture comprises support wings extending laterally toward distal ends of the support wings with respect to a longitudinal axis of the main shaft when the main shaft fixture is engaged with the main shaft, the support wings contoured and shaped to adapt the main shaft fixture to being supported on the longitudinal rails.

4. The system of claim 3, wherein the support wings comprise at least partially sinusoidal bottom edges extending between the arcuate recess and the distal ends of the support wings.

5. The system of claim 3, wherein the support wings comprise vertically-oriented bolt holes proximate the distal ends of the support wings through which bolts are insertable to secure the main shaft fixture to the longitudinal rails from above the longitudinal rails.

6. The system of claim 3, wherein the support wings comprise:
at least partially sinusoidal bottom edges extending between the arcuate recess and the distal ends of the support wings; and,
vertically-oriented bolt holes proximate the distal ends through which bolts are insertable to secure the main shaft fixture to the longitudinal rails from above the longitudinal rails.

7. The system of claim 1, wherein the main shaft fixture comprises:
a horizontally-oriented top plate with a flat top surface, the top plate securable to and extending laterally between the longitudinal rails with respect to a longitudinal axis of the main shaft when the main shaft fixture is engaged with the main shaft;
at least two vertically-oriented parallel spaced-apart support plates attached to and extending downwardly from a bottom surface of the top plate, the support plates having bottom edges comprising arcuate notches that divide each of the support plates into two sections extending laterally toward distal ends of the sections with respect to a longitudinal axis of the main shaft when the main shaft fixture is engaged with the main shaft; and,
a half-pipe plate having a convex upper surface attached to the bottom edges of the support plates within the arcuate notches of the support plates, the half-pipe plate having a concave inner surface defining the arcuate recess of the main shaft fixture.

8. The system of claim 7, wherein the top plate has vertically-oriented bolt holes proximate ends of the top plate through which bolts are insertable to secure the top plate to the longitudinal rails from above the longitudinal rails.

9. The system of claim 7, wherein the sections of the support plates comprise at least partially sinusoidal bottom edges extending between the arcuate notches and the distal ends of the sections.

10. The system of claim 7, wherein the main shaft fixture further comprises inner-plate assemblies extending between and attached to inner surfaces of the parallel spaced-apart support plates.

11. The system of claim 10, wherein the inner-plate assemblies are further attached to the bottom surface of the top plate and the convex upper surface of the half-pipe plate.

12. The system of claim 1, wherein the arcuate recess is lined with a flexible buffer.

13. The system of claim 1, wherein the jack is a pedestal jack.

14. The system of claim 1, wherein the jack is a hydraulic jack.
